(19) United States
(12) Patent Application Publication
(10) Pub. No.: US 2026/0195700 A1
(43) Pub. Date: Jul. 9, 2026

(54) INTEGRATED VEHICLE-DELIVERY-DATE NOTIFICATION SYSTEM AND METHOD THEREFOR

(71) Applicants: Hyundai Motor Company, Seoul (KR); Kia Corporation, Seoul (KR)

(72) Inventors: Seung Hyeon KIM, Goyang-si, Gyeonggi-do (KR); Suk Jae YOUN, Yongin-si, Gyeonggi-do (KR); Jae Hoon JUNG, Seoul (KR)

(73) Assignees: Hyundai Motor Company, Seoul (KR); Kia Corporation, Seoul (KR)

(21) Appl. No.: 18/862,325

(22) PCT Filed: Dec. 20, 2022
(86) PCT No.: PCT/KR2022/020812

§ 371 Date: Nov. 1, 2024

(30) Foreign Application Priority Data
May 12, 2022 (KR) 10-2022-0058496

(51) Int. Cl. G06Q 10/0833; G06Q 10/0631; G06Q 50/04

(52) U.S. Cl. CPC G06Q 10/0833; G06Q 10/06312; G06Q 50/04

(57) ABSTRACT

Proposed are an integrated vehicle-delivery-date notification system and a method therefor. The system includes a production plan establishment part configured to establish a vehicle production plan, a delivery date request part configured to request, based on the established production plan, an expected delivery date for a delivery date inquiry vehicle satisfying vehicle model information and option information, a delivery date computation part configured to compute, based on the established production plan, the expected delivery date for the delivery date inquiry vehicle satisfying the vehicle model information and the option information, and revise the expected delivery date when the production plan is revised, and a delivery date notification part configured to set and notify the expected delivery date computed by the delivery date computation part to a customer, and notify the customer of the revised expected delivery date when the production plan is revised.

### TECHNICAL FIELD

The present disclosure relates to an integrated vehicle-delivery-date notification system and a method therefor. More particularly, the present disclosure relates to an integrated vehicle-delivery-date notification system and a method therefor, wherein an expected delivery date is set based on a pre-established production plan before a vehicle order and is notified to a customer, and after the customer's order, delivery date information, such as delivery date changes and a scheduled out-of-factory date, is notified, and when there are changes to the production plan, this is automatically notified to the customer, thereby forwarding the customer with highly accurate information before and after the vehicle order and reducing labor.

### BACKGROUND ART

Generally, when a customer orders a vehicle, a salesperson notifies the customer of an expected delivery date for the ordered vehicle, and the expected delivery date is computed on a monthly basis.

Changes occurring during the month for each vehicle cannot be applied in real time to the computed expected delivery date by vehicle. Inconstant updates cause a customer who has ordered a vehicle to be notified of an expected delivery date different from the actual delivery date, thus losing customer trust.

Therefore, there is a need for a method of automatically computing an expected delivery date depending on a pre-established production plan before a customer's vehicle order and a production plan established after the vehicle order and notifying the customer of the expected delivery date, thereby increasing customer trust and notifying the customer of an accurate expected delivery date. As the related art for this, there is KR 10-2013-0058196 A.

The foregoing is intended merely to aid in the understanding of the background of the present disclosure, and is not intended to mean that the present disclosure falls within the purview of the related art that is already known to those skilled in the art.

DISCLOSURE

### Technical Problem

The present disclosure is directed to providing an integrated vehicle-delivery-date notification system and a method therefor, wherein an expected delivery date is set based on a pre-established production plan before a vehicle order and is notified to a customer, and after the customer's order, delivery date information, such as delivery date changes and a scheduled out-of-factory date, is notified, and when there are changes to the production plan, this is automatically notified to the customer, thereby forwarding the customer with highly accurate information before and after the vehicle order and reducing labor.

### Technical Solution

In order to achieve the above objectives, according to the present disclosure, there is provided an integrated vehicle-delivery-date notification system including: a production plan establishment part configured to establish a vehicle production plan; a delivery date request part configured to request, based on the established production plan, an expected delivery date for a delivery date inquiry vehicle satisfying vehicle model information and option information; a delivery date computation part configured to compute, based on the established production plan, the expected delivery date for the delivery date inquiry vehicle satisfying the vehicle model information and the option information, and revise the expected delivery date when the production plan is revised; and a delivery date notification part configured to set the expected delivery date computed by the delivery date computation part and notify a customer of the expected delivery date, and notify the customer of the revised expected delivery date when the production plan is revised.

The delivery date computation part may be configured to generate plan revision information when the customer confirms an order for the delivery date inquiry vehicle for which the delivery date is requested, and compute, based on the plan revision information, the expected delivery date for the delivery date inquiry vehicle satisfying the vehicle model information and the option information, for subsequent notification of the delivery date after the plan revision information is generated.

The integrated vehicle-delivery-date notification system may further include a production plan storage part configured to store the production plan established by the production plan establishment part and the plan revision information generated by the delivery date computation part.

The delivery date computation part may be configured to compute, when there is a build-to-stock (BTS) vehicle matching the vehicle model information and the option information among vehicles for which the production plan is established, the expected delivery date according to the production plan for the BTS vehicle matching the vehicle model information and the option information among vehicles for which the production plan is established.

The delivery date computation part may be configured to generate, when there is no build-to-stock (BTS) vehicle matching the vehicle model information and the option information among vehicles for which the production plan is established, plan revision information such that the production plan includes the delivery date inquiry vehicle satisfying the vehicle model information and the option information, and compute the expected delivery date according to the generated plan revision information.

The delivery date computation part may be configured to generate, based on component lead time, the plan revision information such that the production plan includes the delivery date inquiry vehicle satisfying the vehicle model information and the option information.

The delivery date computation part may be configured to cancel the production plan for the BTS vehicle in the pre-established production plan, and generate the plan revision information such that the production plan includes the delivery date inquiry vehicle satisfying the vehicle model information and the option information as one schedule of the production plan for the canceled BTS vehicle.

The delivery date computation part may be configured to cancel the production plan for the BTS vehicle based on at least one selected from a group of available components, component inventory, and component lead time according to the cancellation of the production plan for the BTS vehicle.

The production plan establishment part may be configured to establish the vehicle production plan considering a plan for a prerequisite procedure including vehicle registration or vehicle authentication, and confirm the vehicle production plan when the prerequisite procedure is completed or revise the vehicle production plan considering a scheduled completion date for a next prerequisite procedure when the prerequisite procedure is incomplete.

The production plan establishment part may be configured to confirm, when the vehicle production plan is established before the prerequisite procedure is completed and the prerequisite procedure is completed before the vehicle production plan is confirmed, the vehicle production plan based on a prerequisite procedure completion date.

The prerequisite procedure may be the right to register a purchasable vehicle, and the completion of the prerequisite procedure may refer to acquisition of the right to register.

In order to achieve the above objectives, according to the present disclosure, there is provided an integrated vehicle-delivery-date notification method including: establishing a vehicle production plan by a production plan establishment part; requesting, based on the established production plan by a delivery date request part, an expected delivery date for a delivery date inquiry vehicle satisfying vehicle model information and option information; computing, based on the established production plan by a delivery date computation part, the expected delivery date for the delivery date inquiry vehicle satisfying the vehicle model information and the option information, and revising the expected delivery date when the production plan is revised; and setting, by a delivery date notification part, the expected delivery date computed by the delivery date computation part and notifying a customer of the expected delivery date, and notifying the customer of the revised expected delivery date when the production plan is revised.

In the computing of the expected delivery date by the delivery date computation part, plan revision information may be generated when the customer confirms an order for the delivery date inquiry vehicle for which the delivery date is requested, and the expected delivery date for the delivery date inquiry vehicle satisfying the vehicle model information and the option information may be computed based on the generated plan revision information.

In the computing of the expected delivery date by the delivery date computation part, when there is a build-to-stock (BTS) vehicle matching the vehicle model information and the option information among vehicles for which the production plan is established, the expected delivery date may be computed according to the production plan for the matching BTS vehicle.

In the computing of the expected delivery date by the delivery date computation part, when there is no build-to-stock (BTS) vehicle matching the vehicle model information and the option information among vehicles for which the production plan is established, plan revision information may be generated such that the production plan includes the delivery date inquiry vehicle satisfying the vehicle model information and the option information, and the expected delivery date may be computed according to the generated plan revision information.

### Advantageous Effects

According to the integrated vehicle-delivery-date notification system and the method therefor according to the present disclosure, an expected delivery date is set based on a pre-established production plan before a vehicle order and is notified to a customer, and after the customer's order, delivery date information, such as delivery date changes and a scheduled out-of-factory date, is notified, and when there are changes to the production plan, this is automatically notified to the customer, thereby forwarding the customer with highly accurate information before and after the vehicle order and reducing labor.

Effects that may be obtained from the present disclosure will not be limited to only the above-described effects. In addition, other effects which are not described herein will become apparent to those skilled in the art from the following description.

### DESCRIPTION OF DRAWINGS

FIG. 1 is a configuration diagram illustrating an integrated vehicle-delivery-date notification system according to an embodiment of the present disclosure.

FIG. 2 is a block diagram illustrating the integrated vehicle-delivery-date notification system shown in FIG. 1.

FIG. 3 is a diagram illustrating the entire process of an integrated vehicle-delivery-date notification system that establishes a production plan for a vehicle from a stage before ordering a customer's vehicle order to a stage taking the vehicle out of the factory, and notifies the customer of an expected delivery date set based on the established production plan.

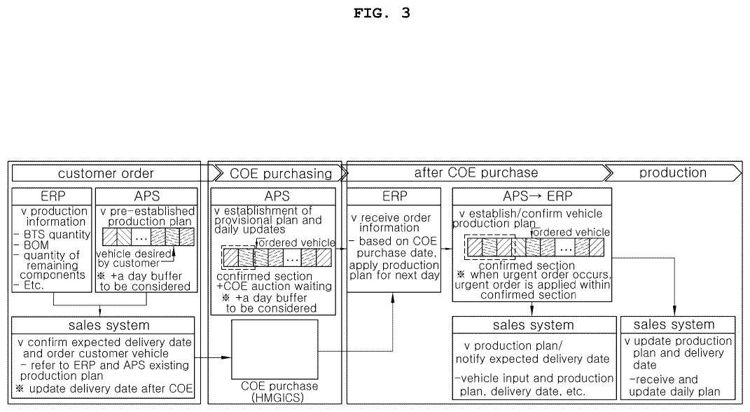

FIG. 4 is a diagram illustrating a delivery date setting method according to whether an order-desired vehicle is scheduled to be out of the factory at the time of the establishment of a production plan of a delivery date notification part, and whether component supply for vehicle production is easy.

FIG. 5 is a diagram illustrating a process of establishing a vehicle production plan by a production plan establishment part distinguishing between completion and non-completion of a prerequisite procedure.

FIG. 6 is a diagram illustrating establishment of a vehicle production plan based on a plan for a prerequisite procedure when a production plan establishment part determines that component supply for vehicle production is impossible.

### MODE FOR DISCLOSURE

Specific structural and functional descriptions of embodiments of the present disclosure described in the specification or application are only for illustrative purposes of the embodiments of the present disclosure. The embodiments of the present disclosure may be embodied in many different forms, and the embodiments of the present specification or application should not be construed as limiting the present disclosure.

Since the embodiment of the present disclosure may be modified in various ways and may have various forms, particular embodiments are shown in the drawings and will be described in the specification or application in detail. However, the embodiment according to the concept of the present disclosure should not be construed as limited to a particular disclosure, and it should be understood that all modifications, equivalents or alternatives falling within the idea and technical scope of the disclosure are included.

Unless otherwise defined, all terms including technical and scientific terms used herein have the same meaning as commonly understood by those skilled in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

Hereinafter, an exemplary embodiment of the present disclosure will be described in detail with reference to the accompanying drawings. The same reference numerals in all the drawings denote the same member.

To notify a customer of a vehicle delivery date, a conventional vehicle-delivery-date notification system computes a monthly delivery date by vehicle, and a salesperson notifies the customer of the computed monthly delivery date by vehicle. Generally, if the expected delivery date is changed after the customer purchases the vehicle, the salesperson notifies the customer of the change in the delivery date through personal contact.

However, this method of notification of a delivery date has three problems.

Firstly, the conventional vehicle-delivery-date notification system computes a monthly delivery date by vehicle, so changes occurring in the month cannot be applied in real time, resulting in a difference from the actual customer delivery date. Accordingly, there is a problem that all customers who visit in that month are notified of the same delivery date.

Secondly, notification of delivery date change through personal contact with a salesperson after vehicle purchase is a manual service by the salesperson, and updates once or twice a month 1~2 may not be performed. Such a sales scheme and customer experiences may lose customer trust and also damage the company's image.

Thirdly, currently, a production plan (vehicle entry sequence) through advanced planning & scheduling (APS) is established only for the minimum period (about 2 weeks) to secure components. Therefore, it is difficult to determine the expected out-of-factory date for a vehicle beyond the 2-week period for which the entry sequence is established, and a salesperson may notify the customer of inaccurate delivery date information, such as notifying only the number of the vehicle model in a sequence.

Lastly, as described above, when inaccurate delivery date information and an expected delivery date based on a salesperson's subjective opinion later than an actual production date are notified, the customer's willingness to purchase the vehicle may decrease. Conversely, when the expected delivery date earlier than the actual production date is notified, a customer claim due to delivery date delay may increase.

Therefore, the present disclosure proposes an integrated vehicle-delivery-date notification system capable of increasing customer trust and providing differentiated customer experiences.

To this end, according to an embodiment of the present disclosure, an expected delivery date is automatically computed depending on a pre-established production plan before a customer's vehicle order and a production plan established after the vehicle order and the expected delivery date is notified to the customer, thereby increasing customer trust and notifying a customer of an accurate expected delivery date.

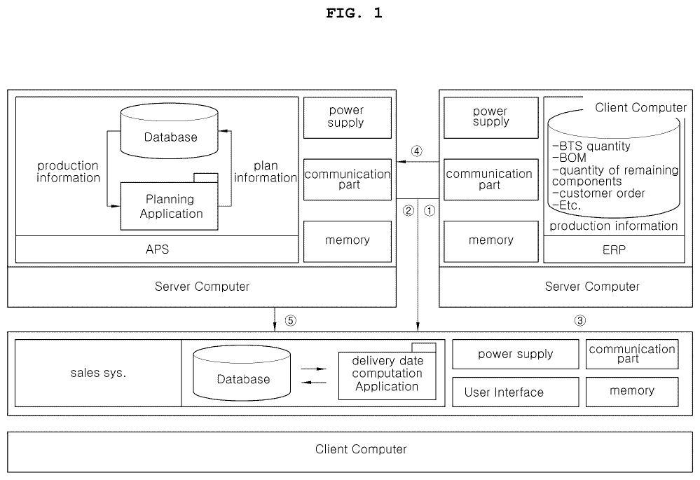

FIG. 1 is a configuration diagram illustrating an integrated vehicle-delivery-date notification system according to an embodiment of the present disclosure. FIG. 1 mainly shows the configuration related to the embodiment. The actual implementation of the system may include fewer or more elements.

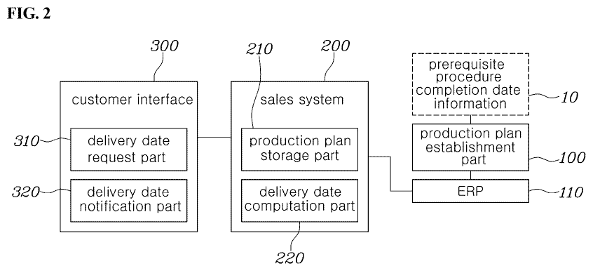

FIG. 2 is a block diagram illustrating the integrated vehicle-delivery-date notification system shown in FIG. 1.

Referring to FIG. 2, an integrated vehicle-delivery-date notification system according to an embodiment may include a production plan establishment part 100, a sales system 200, and an interface 300. The customer interface 300 may include a delivery date request part 310 and a delivery date notification part 320. The sales system 200 may include a production plan storage part 210 and a delivery date computation part 220. Hereinafter, the production plan establishment part 100 and the delivery date notification part 320 will be described first.

The production plan establishment part 100 may be a server computer as shown in FIG. 1. The production plan establishment part 100 may transmit an established production plan to a client computer and notify the customer of the expected delivery date through the delivery date notification part 320. Herein, the production plan establishment part 100 and the delivery date notification part 320 may constitute one server or may be respective servers.

Beforehand, an ERP system may receive production information (BTS quantity, BOM, component supply status, and customer order information) and transmit the same to an APS system or the delivery date notification part 320.

The ERP system is an enterprise resource planning (ERP) system 110 that automates and manages business processes across finance, manufacturing, retail, supply chain, people management, and operations.

In addition, in general, complete-vehicle manufacturers produce vehicles through a build-to-stock (BTS) production method that depends on predicted demand. A BTS vehicle refers to a vehicle produced through a pre-established production plan based on demand prediction.

A vehicle production plan in the production plan establishment part 100 may be established through the advanced planning and scheduling (APS) system. The APS system is a new approach to an optimal plan and scheduling by synchronizing multiple variables and constraints to support realistic and appropriate decision making. Specifically, it refers to a system that enables a company to be competitive, such as an ability to make a production plan, reduction in inventory, shortened lead time, and improvement in customer services.

To summarize FIG. 1, the ERP system may transmit production information to the delivery date notification part 320, and the APS system may transmit pre-established production plan information to the delivery date notification part 320. The delivery date notification part 320 transmits customer order information to the APS system, and the ERP system transmits the customer order information and information on production constraints to the APS system. Afterward, the delivery date notification part 320 sets, based on an established vehicle production plan, an expected delivery date and notifies the customer of the expected delivery date. When the production plan is revised, the delivery date notification part 320 revises the expected delivery date and notifies the customer of the revised expected delivery date.

Herein, the APS system, the ERP system, and the delivery date notification part 320 all have power supplies, communication parts, and memories in common. The delivery date notification part 320 may be further provided in the interface 300 so that a customer is notified of an expected delivery date. Herein, the power supplies, the communication parts, the memories, and the interface 300 are illustrative, and no limitation thereto is imposed.

The delivery date notification part 320 may set, based on a vehicle production plan established by the production plan establishment part 100, an expected delivery date and notify the customer of the expected delivery date. When the production plan is revised, the delivery date notification part 320 may revise the expected delivery date and notify the customer of the revised expected delivery date. In addition, when the production plan is revised, the delivery date notification part 320 may notify the customer of production plan changes. The customer is notified of the production plan changes and can understand the causes of the delivery date change. This plays a positive role in establishing a sales scheme and obtains customer trust.

The delivery date notified to the customer by the delivery date notification part 320 may include at least one selected from the group of delivery date changes, a scheduled out-of-factory date, work start/end time for each process, and component supply status. The delivery date changes may include component lead time changes depending on the component supply status. This is illustrative and is not limited thereto. In addition, the work start/end time for each process is notified to the customer, so that the customer can understand the production progress of his or her ordered vehicle according to the production plan, which also improves customer trust.

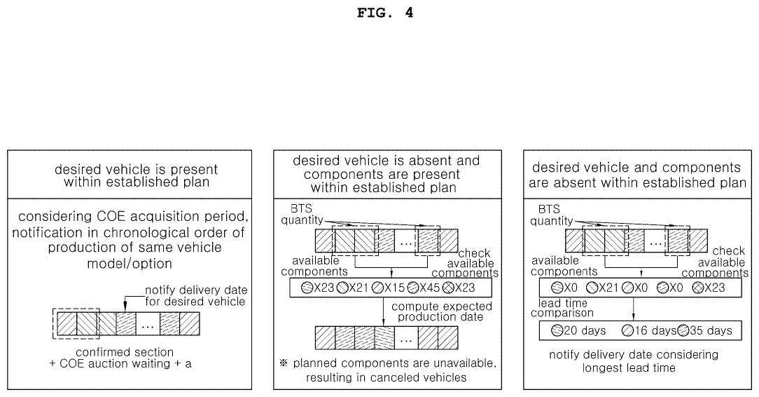

FIG. 4 is a diagram illustrating a delivery date setting method according to whether an order-desired vehicle is scheduled to be out of the factory at the time of the establishment of a production plan of the delivery date notification part 320, and whether component supply for vehicle production is easy.

The production plan establishment part 100 generally establishes a production plan once a day, the established plan is stored in the production plan storage part 210, and a delivery date based on the stored production plan is notified. The production plan storage part 210 may store the production plan established by the production plan establishment part 100 and plan revision information generated by the delivery date computation part 220. The delivery date notification part 320 may notify the customer of an expected delivery date computed based on the production plan and the plan revision information stored in the production plan storage part 210.

Referring to FIG. 4, through the interface 300, a build-to-stock (BTS) vehicle matching vehicle model information and option information is found. When there is a build-to-stock (BTS) vehicle matching the vehicle model information and the option information among vehicles for which the production plan is established, the delivery date computation part 220 may compute the expected delivery date according to the production plan for the matching BTS vehicle. In this case, the delivery date may be notified based on pre-computed production time information of the BTS vehicle, thus notifying the customer of an accurate expected delivery date quickly. Herein, the delivery date computation part 220 may generate the plan revision information when the customer confirms the order for a delivery date inquiry vehicle for which the delivery date is requested. Even before ordering a vehicle, the customer may request the delivery date for the vehicle that the customer wants to order. For the delivery date inquiry vehicle for which the delivery date is requested, the customer may confirm or cancel the order. Herein, when the customer confirms the order for the vehicle for which the delivery date is inquired about, plan revision information may be generated, such as setting order of priority so that the vehicle for which the order is confirmed has a higher priority than a vehicle (BTS vehicle) scheduled to be produced according to a pre-established production plan. Therefore, according to the generated plan revision information, the delivery date computation part 220 computes, based on the plan revision information, the expected delivery date for the delivery date inquiry vehicle that satisfies the vehicle model information and the option information, and the customer who has confirmed the vehicle order is notified of the computed expected delivery date.

However, when the delivery date computation part 220 determines that there is no build-to-stock (BTS) vehicle matching the vehicle model information and the option information among the vehicles for which the production plan is established, the delivery date computation part 220 generates plan revision information such that the production plan includes the delivery date inquiry vehicle satisfying the vehicle model information and the option information, and computes an accurate expected delivery date according to the generated plan revision information.

Herein, when there is no matching BTS vehicle, the delivery date computation part 220 may cancel the production plan for the BTS vehicle in the pre-established production plan to save time for production and secure needed components.

Specifically, the ERP 110 may secure available component information and component inventory information that may be secured because of the canceled BTS vehicle and component information required to produce the vehicle satisfying the vehicle model information and the option information requested by the customer. The secured available component information and component inventory information may be directly forwarded to the sales system 200 through the ERP 110. The plan revision information may be generated based on available components and component inventory status received from the sales system 200. When the delivery date computation part 220 determines that there is no matching BTS vehicle and cancels the production plan for the BTS vehicle, the available components and the component inventory status according to the cancellation of the production plan may be checked to generate the plan revision information.

Herein, the delivery date computation part 220 generates the plan revision information such that the production plan includes the delivery date inquiry vehicle satisfying the vehicle model information and the option information as one schedule of the production plan for the canceled BTS vehicle. Accordingly, the production plan for the delivery date inquiry vehicle is prioritized and the customer is notified of an earlier expected delivery date. Accordingly, the generated plan revision information is applied again in establishing the production plan and the customer is notified, thereby forwarding the customer with highly accurate information before and after the vehicle order and reducing labor.

Specifically, even considering available components and component inventory that may be secured because of a BTS vehicle, when it is difficult to secure components needed to produce the delivery date inquiry vehicle satisfying the vehicle model information and the option information, it may be necessary to consider the lead time, such as importing the needed components due to difficulty in component supply. Herein, when the lead time for the needed components is long, vehicle production is difficult and the delivery date inquiry vehicle may not be assigned to the expected delivery date. When the delivery date computation part 220 determines that there is no matching BTS vehicle and cancels the production plan for the BTS vehicle, the delivery date computation part 220 cancels the production plan for the BTS vehicle based on at least one selected from the group of the available components, the component inventory, and the component lead time according to the cancellation of the production plan for the BTS vehicle, so that the delivery date notification part 320 notifies the customer of an accurate expected delivery date according to component management. Herein, the available components, the component inventory, and the component lead time that the delivery date computation part 220 considers are illustrative and no limitation thereto is imposed. Any factors that affect the computation of the expected delivery date may be included.

Herein, the delivery date notification part 320 inquires about the pre-established production plan information to check the available components and the component inventory status first. When essential components of the delivery date inquiry vehicle are insufficient and the components need to be separately supplied, the customer may be notified of, as an expected delivery date, the earliest production date that is a scheduled out-of-factory date according to component supply, considering the longest lead time for the components.

For reference, the setting of the expected delivery date and customer notification by the delivery date notification part 320 are initially performed based on the production plan received from the production plan establishment part 100. The plan revision information repeatedly updated according to the confirmation of the customer's vehicle order may be stored in the sales system 200. The plan revision information stored in the sales system 200 may be forwarded to the production plan establishment part 100 after the close of business on the day or the close of sales and may be applied in establishing the next production plan. Herein, in the case of simple inquiry about the plan revision information, there is no update to or storage in the sales system 200. A prerequisite procedure described below may be considered when the production plan establishment part 100 first establishes a production plan.

For example, in the delivery date notification system including the production plan establishment part 100 in which a production plan is established once a day, a production plan established on the previous day may first be forwarded to the sales system 200. The sales system 200 allows the delivery date notification part 320 to notify the customer of an expected delivery date based on the received production plan on the day. Herein, while the delivery date notification part 320 notifies the expected delivery date, the production plan revised according to order confirmation may be continually updated or stored in the production plan storage part 210. The delivery date notification part 320 may notify the customer of the production plan updated based on the time of notification.

When the day's sales end, no further delivery date notification and order confirmation are made. The final production plan revised according to order confirmation is forwarded to the production plan establishment part 100 and applied in establishing the next production plan. Afterward, the next production plan to which the final production plan is applied may be forwarded back to the sales system 200 and stored.

In addition, considering a plan for the prerequisite procedure including vehicle registration or vehicle authentication, the production plan establishment part 100 may establish the vehicle production plan. When the prerequisite procedure is completed, the production plan establishment part 100 may confirm the vehicle production plan. When the prerequisite procedure is not completed, the production plan establishment part 100 may revise the vehicle production plan, considering a scheduled completion date for the next prerequisite procedure.

Herein, the prerequisite procedure is the right to register a purchasable vehicle, and the completion of the prerequisite procedure refers to the acquisition of the right to register. Including registration of a purchasable vehicle or authentication of the vehicle, the prerequisite procedure may be a requisite procedure that the customer must obtain before driving the vehicle. For example, Singapore has the Certificate of Entitlement (COE) system. The COE refers to a vehicle-targeted license system that was introduced to regulate the total number of vehicles in the country in order to meet limitations of Singapore's small land area as a city-state.

The COE refers to a certificate that gives the right to drive a vehicle, and the usage period is 10 years. When the COE expires after 10 years, the vehicle may be de-registered or the cost of an additional usage period may be paid. The COE may be obtained through competitive auctions held twice a month. In Singapore, a production plan is established on the assumption that the COE is purchased in time for an auction. The present disclosure is not limited to the COE, and is assumed to include all requisite procedures that must be obtained before driving a vehicle, including vehicle registration or vehicle authentication.

Considering the plan for the prerequisite procedure, the production plan establishment part 100 may establish the vehicle production plan. After the establishment of the production plan, when the customer completes the prerequisite procedure, the production plan establishment part 100 may confirm the vehicle production plan.

The production plan establishment part 100 may establish a production plan for a vehicle, considering the time of completion of the prerequisite procedure that needs to precede the establishment of the production plan. In Singapore, the COE exists as the prerequisite procedure. In the Republic of Korea, when it is determined that the prerequisite procedure is not required, the production plan establishment part 100 may turn off the function so that the plan for the prerequisite procedure is not considered, and may establish the production plan.

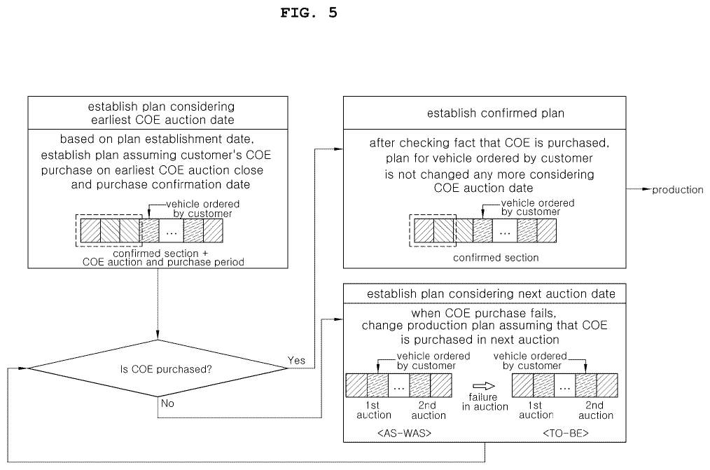

As shown in FIG. 5, the production plan establishment part 100 may establish the production plan, considering the prerequisite procedure completion date. The prerequisite procedure completion date refers to the earliest requisite procedure completion date, and in Singapore, may refer to the COE purchase date or the COE auction closing date.

Afterward, when the prerequisite procedure is completed, the production plan establishment part 100 checks that the prerequisite procedure is completed, and confirms the production plan for the vehicle ordered by the customer without changing the production plan. Production is performed according to the production plan for the vehicle confirmed by the production plan establishment part 100, and the delivery date notification part 320 may notify the customer of a more accurate expected delivery date.

However, when the prerequisite procedure is not completed, the vehicle production plan is revised, considering the scheduled completion date for the next prerequisite procedure. Herein, it will be appreciated by those skilled in the art that the scheduled completion date for the next prerequisite procedure refers to the next auction date among the auction dates for the COE on which auctions are conducted twice a month in Singapore, and when the customer is unable to bid for the COE on the next auction date, the scheduled completion date for the next prerequisite procedure refers to the auction date following the next auction date.

When the vehicle production plan is established before completion of the prerequisite procedure and the prerequisite procedure is completed before confirmation of the vehicle production plan, the production plan establishment part 100 may confirm the vehicle production plan based on the prerequisite procedure completion date. When the production plan establishment part 100 establishes the vehicle production plan considering the plan for the prerequisite procedure before the prerequisite procedure is completed, the production plan is not confirmed and the production plan is revised considering the scheduled completion date for the next prerequisite procedure.

However, when the customer completes the prerequisite procedure before the production plan is revised considering the scheduled completion date for the next prerequisite procedure, the production plan establishment part 100 confirm the production plan immediately based on the prerequisite procedure completion date to perform production, thereby reducing labor and increasing the efficiency of production plan establishment.

The production plan establishment part 100 may establish the vehicle production plan based on at least one selected from the group of the component supply status, the plan for the prerequisite procedure, and the vehicle order date for the customer. As described above, establishing the production plan considering the prerequisite procedure is important to forward highly accurate information to the customer before and after the vehicle order. In addition, when component supply for vehicle production is easy, the production plan may be accelerated and the delivery date notification part 320 may set an early delivery date. When component supply is difficult, the production plan may be delayed and the delivery date notification part 320 may set a late delivery date. In addition, it will be appreciated that the component supply status and the plan for the prerequisite procedure vary with the vehicle order date for the customer and the delivery date may be changed.

The component supply status, the plan for the prerequisite procedure, and the vehicle order date for the customer descried above as considerations for the establishment of the vehicle production plan by the production plan establishment part 100 are illustrative and no limitation thereto is imposed. It will be appreciated by those skilled in the art that any factors which may be considered for the establishment of the production plan may be included.

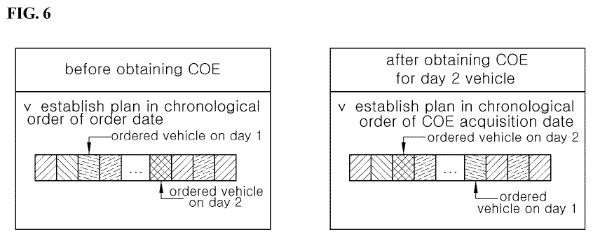

FIG. 6 is a diagram illustrating establishment of the vehicle production plan based on the plan for the prerequisite procedure when the production plan establishment part 100 determines that component supply for vehicle production is impossible.

As shown in FIG. 6, when component supply for vehicle production is impossible, the production plan establishment part 100 may establish the vehicle production plan based on the plan for the prerequisite procedure. When the production plan establishment part 100 establishes the vehicle production plan considering the plan for the prerequisite procedure, the case in which vehicle component supply is impossible may occur. In this case, it is preferable that the vehicle production plan is established by setting order of priority so that whether the prerequisite procedure is completed has a higher priority than the vehicle order date for the customer.

For example, before the prerequisite procedure is completed, when the customer orders vehicles on day 1 and day 2, the vehicle ordered on day 1 has the earlier order date, so the production plan for the vehicle ordered on day 1 is first established. However, when the customer orders vehicles on day 1 and day 2 and the customer ordering on day 2 first completes the prerequisite procedure, the production plan for the vehicle for the customer ordering on day 2 is first established based on the completion date of the prerequisite procedure. Accordingly, an accurate expected delivery date revised according to prerequisite procedure completion date information 10 may be notified.

Based on the integrated vehicle-delivery-date notification system described above, an integrated vehicle-delivery-date notification method according to an embodiment will be briefly described.

First, the production plan establishment part 100 may establish a vehicle production plan. Afterward, at a request of a customer, the delivery date request part 310 may request, based on the established production plan, an expected delivery date for a delivery date inquiry vehicle satisfying vehicle model information and option information. The delivery date computation part 220 may compute, based on the established production plan, the expected delivery date for the delivery date inquiry vehicle satisfying the vehicle model information and the option information, and may revise the expected delivery date when the production plan is revised. The delivery date notification part 320 may set the expected delivery date computed by the delivery date computation part 220 and notify the customer of the expected delivery date. When the production plan is revised, the revised expected delivery date is notified to the customer, thereby forwarding the customer with highly accurate information before and after the vehicle order and reducing labor.

Detailed technical features of each step of the integrated vehicle-delivery-date notification method according to the present disclosure are the same or similar to the technical features of each element of the integrated vehicle-delivery-date notification system according to the present disclosure described above, so a detailed description of the technical features will be omitted.

Although a particular embodiment of the present disclosure has been described for illustrative purposes, those skilled in the art will appreciate that various modifications, additions, and substitutions are possible, without departing from the technical idea of the disclosure as disclosed in the accompanying claims.

### DESCRIPTION OF THE REFERENCE NUMERALS IN THE DRAWINGS

10: prerequisite procedure completion date information
100: production plan establishment part
110: ERP
200: sales system
210: production plan storage part
220: delivery date computation part
300: interface
310: delivery date request part
320: delivery date notification part

1. An integrated vehicle-delivery-date notification system, comprising:
a production plan establishment part configured to establish a vehicle production plan;
a delivery date request part configured to request, based on the established production plan, an expected delivery date for a delivery date inquiry vehicle satisfying vehicle model information and option information;
a delivery date computation part configured to compute, based on the established production plan, the expected delivery date for the delivery date inquiry vehicle satisfying the vehicle model information and the option information, and revise the expected delivery date when the production plan is revised; and
a delivery date notification part configured to set the expected delivery date computed by the delivery date computation part and notify a customer of the expected delivery date, and notify the customer of the revised expected delivery date when the production plan is revised.

2. The integrated vehicle-delivery-date notification system of claim 1, wherein the delivery date computation part is configured to generate plan revision information when the customer confirms an order for the delivery date inquiry vehicle for which the delivery date is requested, and compute, based on the plan revision information, the expected delivery date for the delivery date inquiry vehicle satisfying the vehicle model information and the option information, for subsequent notification of the delivery date after the plan revision information is generated.

3. The integrated vehicle-delivery-date notification system of claim 2, further comprising
a production plan storage part configured to store the production plan established by the production plan establishment part and the plan revision information generated by the delivery date computation part.

4. The integrated vehicle-delivery-date notification system of claim 1, wherein the delivery date computation part is configured to compute, when there is a build-to-stock (BTS) vehicle matching the vehicle model information and the option information among vehicles for which the production plan is established, the expected delivery date according to the production plan for the BTS vehicle matching the vehicle model information and the option information among vehicles for which the production plan is established.

5. The integrated vehicle-delivery-date notification system of claim 1, wherein the delivery date computation part is configured to generate, when there is no build-to-stock (BTS) vehicle matching the vehicle model information and the option information among vehicles for which the production plan is established, plan revision information such that the production plan includes the delivery date inquiry vehicle satisfying the vehicle model information and the option information, and compute the expected delivery date according to the generated plan revision information.

6. The integrated vehicle-delivery-date notification system of claim 5, wherein the delivery date computation part is configured to generate, based on component lead time, the plan revision information such that the production plan includes the delivery date inquiry vehicle satisfying the vehicle model information and the option information.

7. The integrated vehicle-delivery-date notification system of claim 5, wherein the delivery date computation part is configured to cancel the production plan for the BTS vehicle in the pre-established production plan, and generate the plan revision information such that the production plan includes the delivery date inquiry vehicle satisfying the vehicle model information and the option information as one schedule of the production plan for the canceled BTS vehicle.

8. The integrated vehicle-delivery-date notification system of claim 7, wherein the delivery date computation part is configured to cancel the production plan for the BTS vehicle based on at least one selected from a group of available components, component inventory, and component lead time according to the cancellation of the production plan for the BTS vehicle.

9. The integrated vehicle-delivery-date notification system of claim 1, wherein the production plan establishment part is configured to establish the vehicle production plan considering a plan for a prerequisite procedure including vehicle registration or vehicle authentication, and confirm the vehicle production plan when the prerequisite procedure is completed or revise the vehicle production plan considering a scheduled completion date for a next prerequisite procedure when the prerequisite procedure is incomplete.

10. The integrated vehicle-delivery-date notification system of claim 9, wherein the production plan establishment part is configured to confirm, when the vehicle production plan is established before the prerequisite procedure is completed and the prerequisite procedure is completed before the vehicle production plan is confirmed, the vehicle production plan based on a prerequisite procedure completion date.

11. The integrated vehicle-delivery-date notification system of claim 9, wherein the completion of the prerequisite procedure refers to acquisition of the registered right.

12. An integrated vehicle-delivery-date notification method, comprising:
establishing a vehicle production plan by a production plan establishment part;
requesting, based on the established production plan by a delivery date request part, an expected delivery date for a delivery date inquiry vehicle satisfying vehicle model information and option information;
computing, based on the established production plan by a delivery date computation part, the expected delivery date for the delivery date inquiry vehicle satisfying the vehicle model information and the option information, and revising the expected delivery date when the production plan is revised; and
setting, by a delivery date notification part, the expected delivery date computed by the delivery date computation part and notifying a customer of the expected delivery date, and notifying the customer of the revised expected delivery date when the production plan is revised.

13. The integrated vehicle-delivery-date notification method of claim 12, wherein in the computing of the expected delivery date by the delivery date computation part, plan revision information is generated when the customer confirms an order for the delivery date inquiry vehicle for which the delivery date is requested, and the expected delivery date for the delivery date inquiry vehicle satisfying the vehicle model information and the option information is computed based on the generated plan revision information.

14. The integrated vehicle-delivery-date notification method of claim 12, wherein in the computing of the expected delivery date by the delivery date computation part, when there is a build-to-stock (BTS) vehicle matching the vehicle model information and the option information among vehicles for which the production plan is established, the expected delivery date is computed according to the production plan for the BTS vehicle matching the vehicle model information and the option information among vehicles for which the production plan is established.

15. The integrated vehicle-delivery-date notification method of claim 12, wherein in the computing of the expected delivery date by the delivery date computation part, when there is no build-to-stock (BTS) vehicle matching the vehicle model information and the option information among vehicles for which the production plan is established, plan revision information is generated such that the production plan includes the delivery date inquiry vehicle satisfying the vehicle model information and the option information, and the expected delivery date is computed according to the generated plan revision information.
